(19) United States
(12) Patent Application Publication
(10) Pub. No.: US 2025/0330881 A1
(43) Pub. Date: Oct. 23, 2025

(54) SYSTEMS AND METHODS FOR END-TO-END NETWORK POWER OPTIMIZATION BASED USER EQUIPMENT HANDOVER

(71) Applicant: HFCL Limited, Bangalore (IN)

(72) Inventors: Subhas Chandra Mondal, Bangalore (IN); Valluri Satyanarayana Murthy, Bangalore (IN)

(21) Appl. No.: 19/182,587

(22) Filed: Apr. 18, 2025

(30) Foreign Application Priority Data
Apr. 18, 2024 (IN) 202441031163

(51) Int. Cl. H04W 36/00

(52) U.S. Cl. CPC H04W 36/0069

(57) ABSTRACT

Systems (100) and methods (200) for end-to-end network power optimization in a wireless communication device are described. In particular, the method (200) includes receiving a request message for session establishment from a primary base station (112-1) in the access network, and determining an energy profile corresponding to each of one or more secondary base stations (112-2) and the primary base station (112-1), the energy profile corresponding to a service associated with the user equipment (116). Further, the method (200) includes determining an optimal base station, from among the primary base station (112-1) and the one or more secondary base stations (112-2), for enabling the service, based on a comparison of the energy profile of said each of the one or more secondary base stations (112-2) and the primary base station (112-1).

### CROSS REFERENCE TO RELATED APPLICATIONS

The present application claims the benefit of Indian Patent Application number 202441031163 filed on Apr. 18, 2024, the contents of which are incorporated herein by reference in their entirety.

### TECHNICAL FIELD

The present disclosure, in general, relates to managing power in a wireless communication network, and in particular, relates to systems and methods for end-to-end network power optimization based user equipment handover.

### BACKGROUND

Efficient energy utilization is increasingly critical in the context of advancing wireless technologies such as 5G and the forthcoming 6G. While existing solutions address energy management at a network node or device level, there remains a gap in effectively computing energy consumption on a per-service basis. Currently, there is no known system or method for accurately determining energy consumption at the service level.

In wireless networks, network services such as voice and data services are jointly provided by the network and user equipment. Therefore, calculating total energy consumption at the service level necessitates considering energy usage both within the network infrastructure and at the user equipment. Optimizing user equipment (UE) transmit power is essential for achieving end-to-end network energy efficiency.

The current solutions fail to identify an optimal base station that integrates power optimization from both the base station and UE perspectives, particularly during UE initial cell selection or cell reselection while the UE is in motion. Consequently, there is a need for a system and a method to select an optimal base station from a candidate cell list of UE, ensuring end-to-end network power optimization without compromising service quality.

### OBJECTS OF THE PRESENT DISCLOSURE

It is an object of the present disclosure to provide a system and a method for end-to-end network power optimization in a network.

It is an object of the present disclosure to determine a policy for optimal base station selection both during initial cell selection by user equipment (UE) or cell reselection while the UE is in motion.

It is an object of the present disclosure to determine the optimal base station based on UE characteristics, base station characteristics as well as the channel conditions.

It is an object of the present disclosure to optimize the power by considering power profiles of UE, base station, traffic load, channel conditions such as path loss, receiver sensitivity, and the like.

### SUMMARY

In an aspect, the present disclosure relates to a method for end-to-end network power optimization in an access network, including receiving, by a processor, a request message for session establishment from a primary base station in the access network, wherein the primary base station is attached to a user equipment in the access network, determining, by the processor, an energy profile corresponding to each of one or more secondary base stations and the primary base station, the energy profile corresponding to a service associated with the user equipment, determining, by the processor, an optimal base station, from among the primary base station and the one or more secondary base stations, for enabling the service, based on a comparison of the energy profile of said each of the one or more secondary base stations and the primary base station, determining, by the processor, if the primary base station and the optimal base station are same, and in response to determining that the primary base station and the optimal base station are same, transmitting, by the processor, a notification to the primary base station and the user equipment, or in response to determining that the primary base station and the optimal base station are not same, initiating, by the processor, a handover of the user equipment from the primary base station to the determined optimal base station.

In an embodiment, the energy profile may include a set of network-monitored power parameters including at least one of: an identifier of a base station, an identifier of the service, a user subscription level, a power allocated for a resource element in the base station for the service, a number of resource elements allocated for the service, a class of the base station, a rated carrier output power for the base station, a power amplifier efficiency in the base station, and a receiver sensitivity of the base station.

In an embodiment, determining, by the processor, the optimal base station may include receiving, by the processor, one or more power parameters from the primary base station and the one or more secondary base stations, estimating, by the processor, a path loss value of the user equipment with respect to the one or more secondary base stations based on the one or more power parameters, and determining, by the processor, the optimal base station from among the primary base station and the one or more secondary base stations based at least on the path loss value.

In an embodiment, the one or more power parameters may include Synchronization Signal (SS) or Physical Broadcast Channel (PBCH) block power, and Reference Signal Received Power (RSRP) parameter in a measurement report from the user equipment.

In an embodiment, if the user equipment is switched on, determining, by the processor, the optimal base station may include calculating, by the processor, a path loss offset value for the primary base station and the one or more secondary base stations based on receiver sensitivity values of the primary base station and the one or more secondary base stations, and calculating, by the processor, an effective path loss value corresponding to the primary base station and the one or more secondary base stations based on the path loss offset value and the path loss value, and determining, by the processor, the optimal base station from among the primary base station and the one or more secondary base stations having the highest effective path loss value.

In an embodiment, if the user equipment is connected and moving, determining, by the processor, the optimal base station may include estimating, by the processor, a downlink power required for the service corresponding to the primary base station and the one or more secondary base stations, estimating, by the processor, an uplink power required for the service corresponding to the user equipment, determining, by the processor, a total power required for the service based at least on a first weighted value of the downlink power and a second weighted value of the uplink power, and determining, by the processor, the optimal base station from among the primary base station and the one or more secondary base stations having the lowest total power.

In an embodiment, the notification may include a downlink power required for the service corresponding to the primary base station and an uplink power required for the service corresponding to the user equipment.

In an embodiment, in response to transmitting, by the processor, the notification to the primary base station, the method may include receiving, by the processor, an acknowledgement for accommodating the service according to the energy profile from the primary base station, or receiving, by the processor, a negative acknowledgment from the primary base station.

In an embodiment, in case of the negative acknowledgement, the method may include determining, by the processor, a target base station as the optimal base station from among the one or more secondary base stations, assigning, by the processor, the target base station for accommodating the service, and initiating, by the processor, the handover of the user equipment from the primary base station to the target base station.

In an embodiment, initiating, by the processor, the handover of the user equipment from the primary base station to the optimal base station may include transmitting, by the processor, the power profile corresponding to the service to the optimal base station, and receiving, by the processor, an acknowledgement for accommodating the service according to the power profile from the optimal base station, receiving, by the processor, a negative acknowledgment from the optimal base station.

In an embodiment, the first weighted value may correspond to a first power optimization parameter, and the second weighted value may correspond to a second power optimization parameter, wherein the method may include adaptively determining, by the processor, the first power optimization parameter and the second power optimization parameter based on a user subscription level corresponding to the user equipment.

In another aspect, the present disclosure relates to a system for end-to-end network power optimization in an access network, including a processor, and a memory operatively coupled with the processor, wherein the memory includes processor-executable instructions which, when executed by the processor, cause the processor to receive a request message for session establishment from a primary base station in the access network, wherein the primary base station is attached to a user equipment in the access network, determine an energy profile corresponding to each of one or more secondary base stations and the primary base station, the energy profile corresponding to a service associated with the user equipment, determine an optimal base station, from among the primary base station and the one or more secondary base stations, for enabling the service, based on a comparison of the energy profile of said each of the one or more secondary base stations and the primary base station, determine if the primary base station and the optimal base station are same, and in response to determining that the primary base station and the optimal base station are same, transmit a notification to the primary base station and the user equipment, or in response to determining that the primary base station and the optimal base station are not same, initiate a handover of the user equipment from the primary base station to the determined optimal base station.

In another aspect, the present disclosure relates to a user equipment, including a processor, and a memory operatively coupled with the processor, wherein the memory comprises processor-executable instructions which, when executed by the processor, cause the processor to receive a Synchronization Signal Block (SSB) signal from each of one or more base stations in an access network, determine Reference Signal Received Power (RSRP) parameter for each of the one or more base stations based on the SSB signal, initiate a connection with a primary base station of the one or more base stations based on the RSRP parameter, and receive a notification from a network entity in a core network based on a power profile of the one or more base stations, the notification indicating one of, adjust an uplink power to accommodate the service, or initiate a handover from the primary base station to a secondary base station of the one or more base stations.

### BRIEF DESCRIPTION OF DRAWINGS

The accompanying drawings, which are incorporated herein, and constitute a part of this disclosure, illustrate exemplary embodiments of the disclosed methods and systems which like reference numerals refer to the same parts throughout the different drawings. Components in the drawings are not necessarily to scale, emphasis instead being placed upon clearly illustrating the principles of the present disclosure. Some drawings may indicate the components using block diagrams and may not represent the internal circuitry of each component. It will be appreciated by those skilled in the art that disclosure of such drawings includes the disclosure of electrical components, electronic components, or circuitry commonly used to implement such components.

FIG. 1A illustrates an example architecture of a system in an access network, in accordance with an embodiment of the present disclosure.

FIG. 1B illustrates an example representation of an energy control function (ECF) module, in accordance with an embodiment of the present disclosure.

FIG. 2 illustrates a flow diagram of an example method for implementing end-to-end network power optimization, in accordance with an embodiment of the present disclosure.

FIG. 3 illustrates a sequence diagram for energy profile transfer, in accordance with an embodiment of the present disclosure.

FIG. 4 illustrates a sequence diagram of a method for end-to-end network optimization, in accordance with an embodiment of the present disclosure.

FIG. 5 illustrates a sequence diagram of a method for N2 handover procedure, in accordance with an embodiment of the present disclosure.

FIGS. 6A and 6B illustrate example representations for optimal base station selection, in accordance with embodiments of the present disclosure.

FIG. 7 illustrates an example computer system in which or with which embodiments of the present disclosure may be implemented.

The foregoing shall be more apparent from the following more detailed description of the disclosure.

### DETAILED DESCRIPTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

The ensuing description provides exemplary embodiments only and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth.

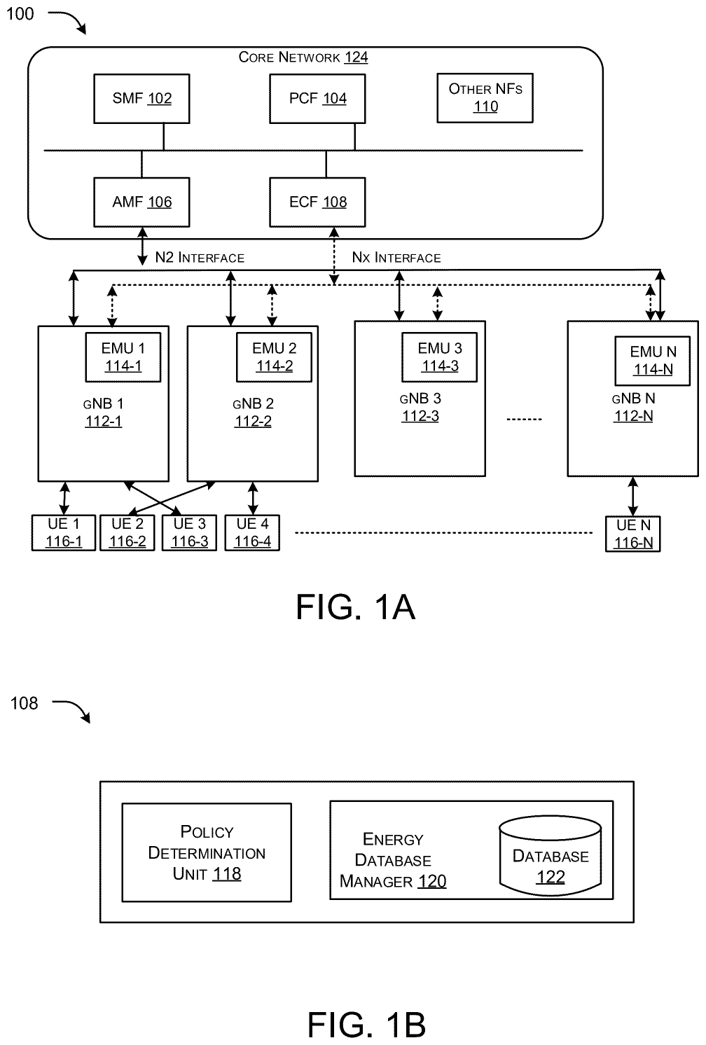

The various embodiments throughout the disclosure will be explained in more detail with reference to FIGS. 1-7.

FIG. 1A illustrates an example architecture of a system (100) in an access network, in accordance with an embodiment of the present disclosure.

In particular, the system (100) includes one or more network function (NF) modules in a core network (124). The system (100) includes a Session Management Function (SMF) module (102) responsible for establishing, maintaining, and terminating user sessions in 5G core network (124). The SMF module (102) manages user plane resources and interacts with User Plane Function (UPF) to ensure that data packets are correctly routed and forwarded.

The system (100) includes a Policy Control Function (PCF) module (104). The PCF module (104) determines and controls policy rules for user services. The PCF module (104) provides a decision-making mechanism for policies like Quality of Service (QOS) rules, charging, and other service-specific behaviours.

The system (100) includes an Access and Mobility Management Function (AMF) module (106) that handles critical control plane functions like registration management, connection management, reachability management, mobility management, and access authentication. The AMF module (106) uses N2 interface for communication with one or more base stations, i.e., gNodeBs (gNBs) (112-1, 112-2, 112-3 . . . 112-N).

Referring to FIG. 1A, the system (100) includes an Energy Control Function (ECF) module (108). The ECF module (108) controls the total energy consumed for a service by determining a policy for each service based on the information given by different base stations (112-1, 112-2, 112-3 . . . 112-N). The ECF module (108) may either be in core network (124) or may reside in Service Management and Orchestration (SMO). The functions of the ECF module (108) will be further described with reference to FIG. 1B.

Referring to FIG. 1A, each gNB (112-1, 112-2, 112-3 . . . 112-N) includes an Energy Monitoring Unit (EMU) (114-1, 114-2, 114-3 . . . 114-N). It may be appreciated that the one or more gNBs (112-1, 112-2, 112-3 . . . 112-N) may be individually referred as the gNB (112) and collectively referred as the gNBs (112). Similarly, the EMUs (114-1, 114-2, 114-3 . . . 114-N) may be individually referred as the EMU (114) and collectively referred as the EMUs (114). The EMU (114) monitors real-time energy consumption on a per service basis and reports to the ECF module (108) in the core network (124). The EMU (114) uses Nx interface to interact with the ECF module (108).

In some embodiments, other network functions (NFs) (110) may be present in the core network (124). Further, one or more user equipment (UE) (116-1, 116-2, 116-3, 116-4 . . . 116-N) may be present in the network, connected to different gNBs (112). It may be appreciated that the one or more UEs (116-1, 116-2, 116-3, 116-4 . . . 116-N) may be individually referred as the UE (116) and collectively referred as the UEs (116).

FIG. 1B illustrates an example representation of an ECF module (108), in accordance with an embodiment of the present disclosure.

Referring to FIG. 1B, the ECF module (108) includes a policy determination unit (118) and an energy database manager (120). The energy database manager (120) manages the data collected from different base stations (e.g., 112) for each service and reports it to the policy determination unit (118) to determine a policy (for corresponding base station per service). The energy database manager (120) stores all the current and historical energy related parameters, workload, and service requirements of all the connected base stations (112) in its local database (122).

The policy determination unit (118) determines energy management policy per user per service based on the information in the energy database manager (120). It may be appreciated that a policy defines that, for a particular service, the energy consumed for particular time interval should be less than or equal to the maximum value (upper threshold) and should be greater than or equal to the minimum value (lower threshold). After policy determination is done, the same information is shared with other core network entities like the SMF module (102), the AMF module (106), and the like.

In accordance with embodiments of the present disclosure, the system (100) determines a policy for optimal base station selection both during initial cell selection by the UE (116) or cell reselection while the UE (116) is in motion. The system (100) determines an optimal base station by incorporating UE characteristics, base station characteristics, and channel conditions.

In some embodiments, the system (100) may be associated with a processor and a memory, such that the memory includes processor-executable instructions which, when executed by the processor, cause the processor to perform the methods described herein. In some embodiments, the gNB (112) and/or the UE (116) may include respective processor and memory for the same.

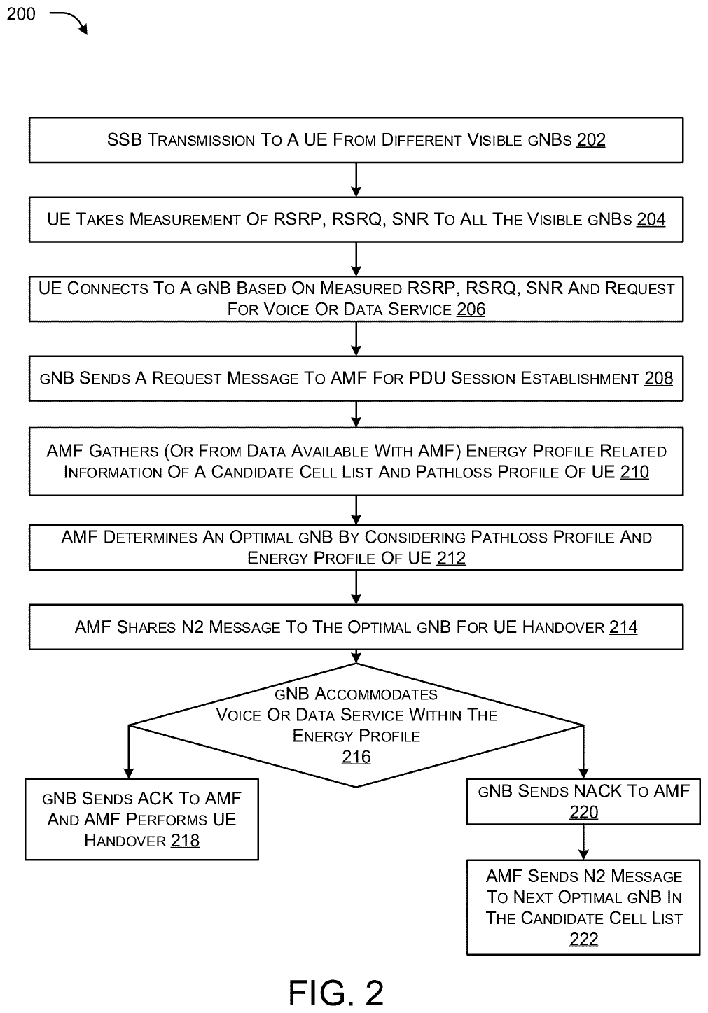

FIG. 2 illustrates a flow diagram of an example method (200) for implementing end-to-end power optimization, in accordance with an embodiment of the present disclosure.

Referring to FIG. 2, at step 202, Synchronization Signal Block (SSB) transmission from different visible base stations, i.e. gNBs (e.g., 112) to a UE (e.g., 116) is performed. Rated carrier output power for different base station types as defined in 3^{rd} Generation Partnership Project (3GPP) Technical Specification (TS) 38.104-1 is given in Tables 1 and 2 below. The rated carrier output power for base station type 1-C is specified in table 6.2.1-1 in the 3GPP standard, as shown in Table 1 below, where P_{rated, c, AC} refers to rated carrier output power per antenna connector.

TABLE 1

| Base Station (BS) Class | P_{rated, c, AC} |
|---|---|
| Wide area BS | (Note) |
| Medium Range BS | ≤38 dBm |
| Local Area BS | ≤24 dBm |

Note:
There is no upper limit for P_{rated, c, AC} of wide area base station.

The rated carrier output power for base station type 1-H is specified in table 6.2.1-2 in the 3GPP standard, as shown in Table 2 below, where P_{rated, c, TABC} refers to rated carrier output power per TAB connector.

TABLE 2

| BS Class | P_{rated, c, sys} | P_{rated, c, TABC} |
|---|---|---|
| Wide area BS | (Note) | (Note) |
| Medium Range BS | ≤38 dBm + 10log(N_{TXU, counted}) | ≤38 dBm |
| Local Area BS | ≤24 dBm + 10log(N_{TXU, counted}) | ≤24 dBm |

Note:
There is no upper limit for P_{rated, c, AC} Of P_{rated, c, TABC} of wide area base station.

In the UE initial attach phase, different base stations (112) may be transmitting SSB block using rated carrier output power, as defined in the above tables. The base station (112) may transmit the SSB block to all the UEs (116) present in its coverage region. SS/PBCH block power (i.e., SSB transmission power) is the average power of all Resource Elements (REs) present in the SSB block. The SS/PBCH power may be calculated by using below formula.

$$\begin{matrix}Power per RE = Maximum output power - 35.1 = 10.9 dB m \\ SS - block power ( EPRE ) = 10.9 dB m\end{matrix}$$

Considering 46 dBm as the channel power for a macro base station, following would be the power calculations:

$$\begin{matrix}Number of REs in a 100 MHz channel = 3276 ; \\ Total channel power for 3276 REs = 10 log ( 3276 ) = 35.1 dB ( ratio of total number of REs in 100 MHz channel against a single RE )\end{matrix}$$

The table 3 below shows the EPRE values of SS/PBCH.

TABLE 3

| | Maximum output power | SS/PBCH block power (EPRE) = |
|---|---|---|
| gNB type | (dBm) | maximum output power − 35.1 (dBm) |
| Wide Area | 46 | 10.9 |
| Medium Area | 38 | 2.9 |
| Local Area | 24 | −11.1 |

Referring to FIG. 2, at step 204, UE (116) performs measurement of one or more parameters with respect to all visible base stations (112). The one or more parameters may include, but not limited to, Reference Signal Received Power (RSRP), Reference Signal Received Quality (RSRQ), Signal to Noise Ratio (SNR), and the like.

The power at which UE (116) receives the SSB block is called RSRP. RSRP depends on various factors such as gNB antenna gains, path loss, cable loss, UE antenna gain, etc. The power received at UE (116) (i.e., RSRP) may be calculated as:

$$Power received at UE ( RSRP ) = gNB transmit power - Cable loss + gNB antenna gain - Path loss - other losses + UE antenna gain$$

If the received RSRP power is greater than UE receiver sensitivity, then UE (116) can decode the signal. If the UE (116) cannot decode the signal and the transmission is not possible, UE (116) calculates the path loss of the SSB signal received from different base stations (112). Further, the UE (116) sends an uplink signal with certain power value so that the base station (112) can fully synchronize with the UE (116).

UE transmission power is given in 3GPP 38.101 (table 6.2.1-1) for different frequency bands. Assuming UE is a class 3 device and operating in n78 band, the maximum output power of UE is 23 dBm. The initial Physical Random Access Channel (PRACH) transmission power may be given as:

$$Power PRACH = minim um of ( maximum transmission power ( 23 dB m ) , PRACH target power + Path loss )$$

Where, PRACH target power=Preamble_received_target_power+Delta_preamble+ (power ramping counter−1)*Power_ramping_step
Where UE 116 receives,
Preamble_received_target_power parameter from Radio Resource Control (RRC) layer in SIB2 message;
Delta_preamble value from RRC layer in SIB2 message;
Power ramping counter is number of retransmissions;
Power_ramping_step is RRC parameter in SIB1 message (rach-configgeneric IE).

In some embodiments, the UE (116) may calculate path loss value as shown below. In an example embodiment, it may be assumed that gNB (112) is transmitting with maximum power of 40 dBm, UE receiver sensitivity is −110 dBm, and UE RSRP is −56 dBm.

$$\begin{matrix}SSS EPRE = 40 - 35.1 = 4.9 dB m \\ Path loss = 4.9 - ( - 56 ) = 60.9 dB\end{matrix}$$

It may be assumed that UE (116) is transmitting with maximum power of 23 dBm and gNB receiver sensitivity is −95.6 dBm.

$$\begin{matrix}Maximum path loss = 23 - ( - 95.6 ) = 118.6 dB \\ PRACH EPRE = 23 - 35.1 = - 12.1 dB m \\ gNB RSRP = - 12.1 - 60.9 dB = - 73 dB m .\end{matrix}$$

Power of the next signal to this gNB (112) should be greater than −34.7 dBm (EPRE).

Referring to FIG. 2, at step 206, the UE (116) connects to a base station (112) based on the measured one or more parameters and requests for a service, i.e., a voice service or a data service. In some embodiments, after the PRACH transmission, the UE (116) connects to the base station (112).

Referring to FIG. 2, at step 208, the base station (112), e.g., a primary base station, sends a request message to an AMF module (e.g., 106) for PDU session establishment. The primary base station may be attached to the UE (116). The procedure for PDU session establishment is described in 3GPP 23.502, clause 4.3.2, and is not described in detail herein for the sake of brevity.

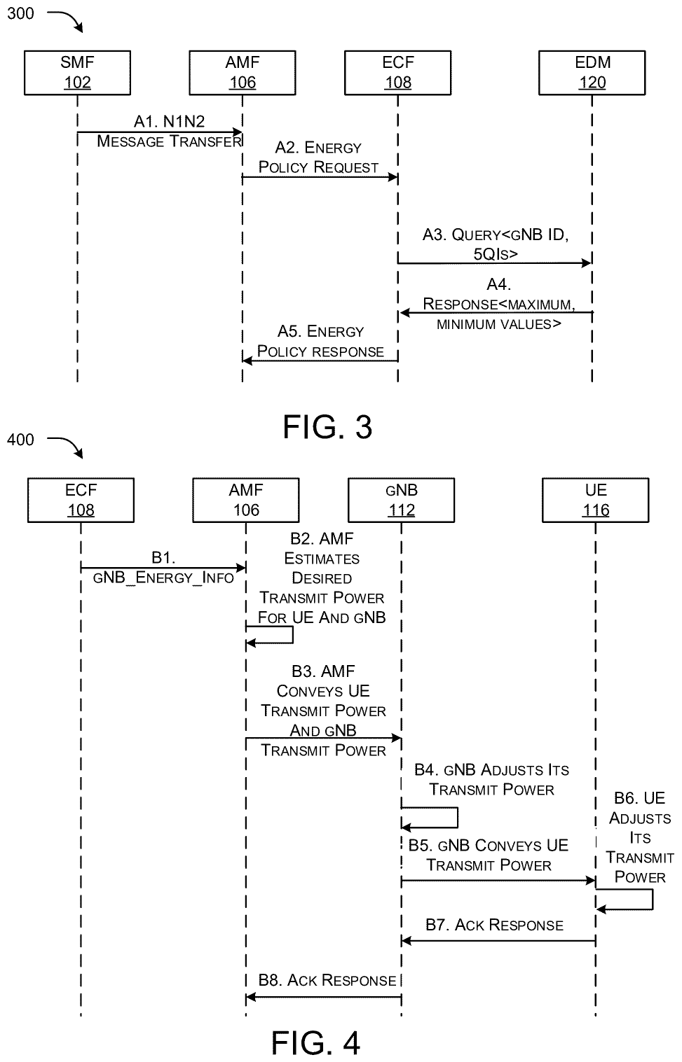

At step 210, the AMF module (106) identifies an energy profile of a candidate cell list, i.e. corresponding to each of one or more secondary base stations and the primary base station. The AMF module (106) identifies energy profile related information of the candidate cell list and pathloss profile of the UE (116) with respect to the base stations (112) in the candidate cell list based on data available at the AMF module (106) or based on gathering information from the ECF module (108). The energy profile may correspond to a service associated with the UE (116). In some embodiments, the AMF module (106) updates Namf_N1N2MessageTransfer message. The AMF module (106) identifies gNB identifier (ID) and extracts 5QI indexes from all the services provided in the PDU session given in N2 SM information message that is present in Namf_N1N2MessageTransfer. The AMF module (106) may request an ECF module (e.g., 108) to send energy related policy for the given gNB ID and 5QI values, as shown in the sequence diagram (300) of FIG. 3.

Specifically, in FIG. 3, at step A1, SMF module (e.g., 102) may transfer N1N2 message to the AMF module (106). At step A2, the AMF module (106) may send an energy policy request to the ECF module (108). At step A3, the ECF module (108) may send a query to an energy database manager (e.g., 120) with the gNB ID and 5QI values. At step A4, the energy database manager (120) sends a response with minimum and maximum values of power corresponding to the gNB ID to the ECF module (108). At step A5, the ECF module (108) sends an energy policy response to the AMF module (106).

In some embodiments, the energy policy response consists of an energy profile that comprises of energy related information of that base station corresponding to the gNB ID, i.e. network-monitored power parameters. The energy profile includes, but not limited to, gNB ID, service ID, user type or user subscription level, energy per resource element, number of REs, gNB class, rated power, power amplifier efficiency, receiver sensitivity of the base station (112), and the like. The gNB ID is used to identify gNBs within a PLMN. The gNB ID is contained within the new radio (NR) cell identity of its cells. The gNB ID is defined in 3GPP 38.300 and 3GPP 38.413 (clause 9.3.1.6). Datatype of the parameter is BIT STRING of size 22-32 bits. The service ID corresponds to a 5QI value, i.e., a set of QoS characteristics that should be used for the QoS flow of the service. The service ID is an unsigned integer defined in 3GPP 23.501 (clause 5.7.4). The service ID may have values from 1 to 86 (as defined in 3GPP 23.501, version 16.6.0). The service provider classifies user into three types (premium, normal, best effort) based on the subscription taken by the user associated with the UE (116). Energy per resource element refers to power allocated for resource element in the base station (112) for a particular service to the UE (16). gNB class may refer to wide area, medium range, or local area classes defined in 3GPP 38.104, clause 6.2.1. Further, the rated carrier output power is defined in 3GPP 38.104 (clause 6.2.1) for different classes of base stations (112).

Referring to FIG. 2, at step 212, the AMF module (106) determines an optimal base station (112) from among the primary base station and the one or more secondary base station in the candidate cell list, for enabling the service, by considering pathloss profile and energy profile of the UE (116) with respect to the base stations (112) in the candidate cell list. In some embodiments, the AMF module (106) determines the optimal base station (112) based on a comparison of the energy profile of each of the base stations (112).

After receiving the energy profile of different base stations (116), the AMF module (106) may determine the optimal base station for the UE (116) for enabling the requested service (for example, voice or data service). This is done by comparing the energy profile and pathloss profile for all the base stations (112). In some embodiments, the AMF module (106) may receive one or more power parameters from the primary base station and the secondary base station(s). For example, the AMF module (106) may receive the gNB configuration parameter from the ECF (108). The configuration parameter consists of base station type, power rating, and Physical Resource Block (PRB) utilization. The AMF module (106) may have prior information about receiver sensitivity and power rating of the base station (112). It may be appreciated that receiver sensitivity is an indicator to show how well a system can decode the received information. The receiver sensitivity is measured in dBm. If received power at gNB (112) is greater than receiver sensitivity of the gNB (112), then only the gNB (112) can successfully decode the information. Different reference sensitivity levels of different base stations are given in 3GPP 38.104.

In an embodiment, considering a scenario where the UE (116) is switched ON and not moving. The gNB (112) has to send SS/PBCH block power to the AMF module (106) for path loss computation. The gNB (112) may send RSRP in the measurement report (sent by the UE (116)) to the AMF module (106). The AMF module (106) may calculate the estimated path loss with respect to the current gNB (112) as SS/PBCH block power-RSRP.

Further, the AMF module (106) estimates path loss of UE (116) with respect to other neighbouring base stations (for example, referring to the candidate cell list), i.e. secondary base station(s) based on the power parameters.

In an example embodiment, it may be assumed that there are three different types of base stations and RSRP measurements by the UE (116). Below table 4 shows the computation of path loss by the AMF module (106).

TABLE 4

| gNB type | SS/PBCH power(dBm) | RSRP(dBm) | Path Loss(dBm) |
|---|---|---|---|
| A | 10.9 | −76.1 | 87 |
| B | 2.9 | −74.1 | 77 |
| C | −11.1 | −85.1 | 74 |

The AMF module (106) may decide based on the base station profiles. Further, the AMF module (106) may consider the receiver sensitivity of base stations as different base stations have different receiver sensitivity.

Receiver sensitivity > UE_PRACH_power + path loss

In an example embodiment, it may be assumed that the UE (116) is already connected to a particular gNB B, then the AMF module (106) may calculate pathloss_offset for the gNB B. Pathloss_offset is an offset value with respect to different base station receiver sensitivity values as shown in the below table 5. Pathloss offset value for the lowest receiver sensitivity base station will be 0 and it will be taken as reference for other base stations.

$$PL\_offset ( dB ) = receiver\_sensitivity \_reference \_gNB - receiver\_sensitivity \_Current \_gNB$$

TABLE 5

| | | | | Effective_pathloss_gNB |
|---|---|---|---|---|
| gNS type | receiver sensitivity(dBm) | PL_offset (dB) | Path Loss(dB) | (path loss − PL_offset)(dB) |
| A | −95.6 | 8 | 87 | 79 |
| B | −90.6 | 3 | 77 | 74 |
| C | −87.6 | 0 | 71 | 73 |

The effective path loss for a gNB (112) refers to the level of path loss at which the gNB (112) can accurately decode information from the UE (116). A gNB (112) with a higher effective path loss can accommodate greater adjustments in UE transmission power. In an example embodiment, it may be assumed that the UE (116) is connected to gNB B, the AMF module (106) identifies that the UE (116) can transmit with 5 dB less power by shifting to the gNB A, which will give a better connectivity to the UE (116). The AMF module (106) may trigger a handover request to the gNB B to handover the UE (116) to gNB A.

It may be appreciated that although three base stations have been considered that are visible to the UE (116) in initial attach as mentioned in the table above. However, in practical scenario, multiple base stations (112) will be visible by the UE (116) of different base station types, for example, two macro base stations, three mid-range base stations, and likewise.

In another embodiment, considering a scenario where the UE (116) is in already RRC_CONNECTED state and moving. When the UE (116) is moving, handover may be triggered based on the measurement report sent by the UE (116.) RRC layer may trigger a handover event which is defined in 3GPP 38.331. Before the handover procedure is initiated, the AMF module (106) may select the best optimal base station from that measurement report sent by the UE (116) and initiate the handover process. AMF module's optimal selection of the base station (112) has to be done at measurement report periodicity. This will avoid multiple handover scenarios getting triggered.

In some embodiments, the UE (116) calculates initial Physical Uplink Shared Channel (PUSCH) transmission power as follows:

$$PUSCH power = min ( max trans power , ( PUSCH target power + 10 log ( {2}^{2} * {M}_{RB} ) + α * PL + Δ + f ) )$$

All the parameters are defined in 3GPP 38.213 (clause 7.1.1). Nominal UE transmit power represents the transmit power when allocated a single resource block (RB) with 15 kHz subcarrier spacing and 0 dB path loss.

$$P {0}_{PUSCH} , b , f , c ( j ) = P {0}_{{NOMINAL}_{PUSCH}} , f , c ( j ) + P {0}_{{UE}_{PUSCH}} , b , f , c ( j ) ,$$

where j∈{0,1, . . . , J−1}
   PO_NOMINAL_PUSCH, f, c(j):
   Nominal UE transmit power represents the transmit power when allocated a single RB with 15 kHz subcarrier spacing and 0 dB path loss.

If j = 0, P0_{NOMINAL}_{_{PUSCH}}, f, c(j) = Preamble_received_target_power +
Delta_preamble
If j = 1, p0-NominalWithoutGrant from PUSCH-PowerControl,
or P₀_{_{—}}_{NOMINAL}_{_{—}}_{PUSCH,f,c}(0) if not provided.
If j = 2, p0-NominalWithGrant from PUSCH-ConfigCommon,
or P₀_{_{—}}_{NOMINAL PUSCH,f,c}(0) if not provided. It's a cell specific power level applicable
to all UEs within the cell.
P0_UE_PUSCH, b, f, c(j) :
If j=0, P0_{UE}_{_{PUSCH}}, b, f, c(j) = 0
If j=1, p0 from p0-PUSCH-Alpha in ConfiguredGrantConfig that provides an
index P0-PUSCH-AlphaSetId to a set of P0-PUSCH-AlphaSet, which is defined
in PUSCH-PowerControl, for active UL BWP b of carrier f of serving cell c.
If j=2, a set of p0 in P0-PUSCH-AlphaSet indicated by a respective set of p0-
PUSCH-AlphaSetId for active UL BWP b of carrier f of serving cell c. It is a UE
specific offset to adjust individual UE performance.

In some embodiments, the gNB (112) may estimate the path loss of PUSCH transmission from the UE (116) and share it to the AMF module (106). The gNB (112) has to send RSRP parameter in the measurement report sent by the UE (116) to the AMF module (106). The AMF module (106) calculates the estimated path loss with respect to the current gNB as shown below:

AMF estimates the path loss=SS/PBCH block power−RSRP.

The AMF module (106) estimates path loss of UE (116) with respect to other neighbouring base stations (i.e., candidate cell list).

In an example embodiment, it may be assumed that there three different types of base stations and RSRP measurements by the UE (116). Below table 6 shows the computation of path loss by AMF module (106).

TABLE 6

| | | | | Effective_pathloss_gNB |
|---|---|---|---|---|
| gNB type | receiver sensitivity(dBm) | PL_offset (dB) | Path Loss(dB) | (path loss − PL_offset)(dB) |
| A | −95.6 | 8 | 87 | 79 |
| B | −90.6 | 3 | 77 | 74 |
| C | −87.6 | 0 | 71 | 71 |

The AMF module (106) may estimate downlink power required for the service with respect to different base stations (112).

$$Total\_power \_tx \_gNB = Energy per resource element + log ( No of resource elements )$$

TABLE 7

| | EPRE | | power_tx_gNB |
|---|---|---|---|
| gNB type | (dBm) | No of RE | (dBm) |
| A | −2 | 60 | −0.221 |
| B | 0 | 50 | 1.698 |
| C | 2 | 45 | 3.653 |

It may be assumed that a UE (116) is connected to gNB B and PUSCH_power for a given service is 0.7 dBm per EPRE.

$$Total\_power \_tx \_UE = Energy per resource element + log ( No of resource elements )$$

TABLE 8

| | EPRE | | power_tx_UE |
|---|---|---|---|
| gNB type | (dBm) | No of RE | (dBm) |
| A | −2.7 | 20 | −1.39 |
| B | 0.7 | 25 | 2.09 |
| C | 3.7 | 20 | 5 |

According to user type in energy profile, the AMF module (106) may change weights of the power and find an optimal base station as shown below.

$$Total\_power \_per \_service = Total\_power \_tx \_gNB * X + Total\_power \_tx \_UE * Y$$

Where, X is weight of the total gNB downlink power
Y is weight of the total gNB uplink power

In some embodiments, users may be categorized in three different types, user type 1, where UE energy optimization gets highest priority, user type 2, where overall energy is optimized at an overall service level with optimal configuration on network and UE device, and user type 3, where base station energy optimization gets highest priority.

TABLE 9

| User type | X | Y |
|---|---|---|
| 1 | 0.4 | 0.6 |
| 2 | 0.5 | 0.5 |
| 3 | 0.6 | 0.4 |

Configuration of weightages for first weighted value, i.e. power optimization parameter X (on base station side) and second weighted value Y (on UE side) can be adaptively identified based on the user type. Accordingly, optimal base station can be identified and handover process is initiated in real-time. For user type 2, equal weightages may be considered for power optimization parameter X (on base station side) and Y (on UE side). The above values of X and Y for user type 1 and user type 3 are just for example purposes. Based on the above calculation, the AMF module (106) may identify optimal base station and accordingly communicate to UE (116).

In some embodiments, the AMF module (106) may calculate and formulate a candidate cell list according to the user type as shown below.

### For User Type 1:

$$Total\_power \_per \_service = Total\_power \_tx \_gNB * 0.4 + Total\_power \_tx \_UE * 0.6$$

TABLE 10

| | Power_tx_gNB | Power_tx_UE | Total_power |
|---|---|---|---|
| gNB type | (dBm) | (dBm) | (dBm) |
| A | −0.221 | −1.39 | −0.9224 |
| B | 1.698 | 2.09 | 1.9332 |
| C | 3.653 | 5 | 4.4612 |

For user type 1, handover should be done from gNB B to gNB A. Accordingly, the AMF module (106) may trigger a handover request to the gNB B to handover the UE (116) to gNB A. For User type 2, the AMF module (106) may take a decision for optimal base station identification where overall network energy (i.e. UE device as well as network device energy) is optimizes. For this, the AMF module (106) may identify base station transmit power and UE transmit power.

In some embodiments, the AMF module (106) may determine if the primary base station and the optimal base station are same. When the optimal base station is same as the already connected base station, the AMF module (106) may identify base station transmit power and transmit a notification to the primary base station (112) and UE (116). The base station (112) and UE (116) may have to adjust the transmit power as received from the AMF module (106).

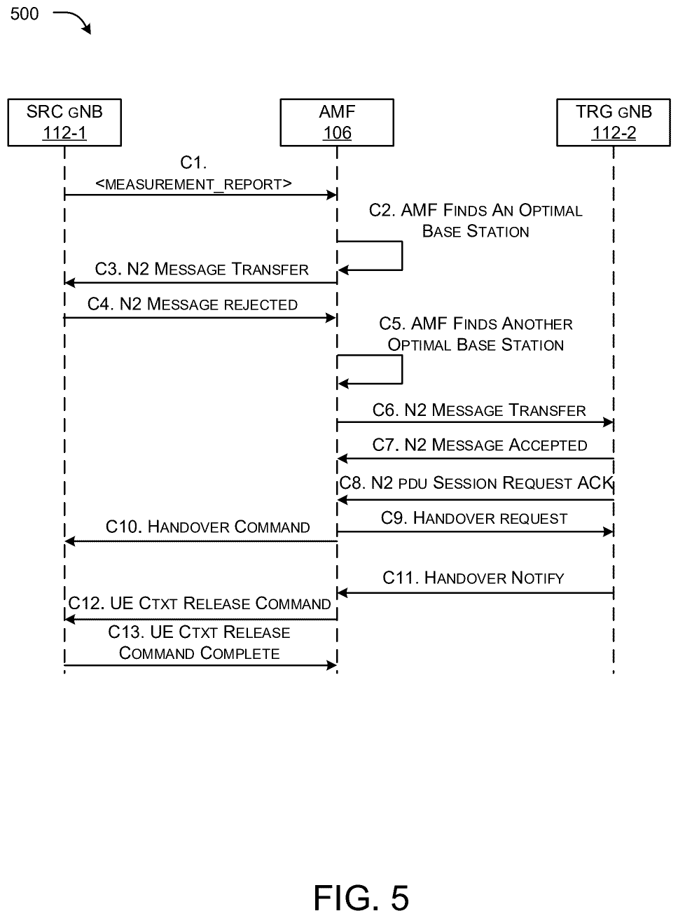

In some other embodiments, when optimal base station is different from the already connected base station, the method 200 may proceed to step 214 of FIG. 2, where a handover may be initiated. Referring back to FIG. 2, at step 214, the AMF module (106) may share N2 message to the identified optimal base station (112) for handover of the UE (116). From step 212, the AMF module (106) may have identified the optimal base station from the candidate cell list and may also have list of other candidate cell arranged in priority list. The AMF module (106) sends an N1N2 message to a source (SRC) gNB. At step 216, the gNB determines whether it can accommodate the service within the energy profile or not. At step 218, SRC gNB sends an acknowledgement (ACK) message to the AMF module (106) if it can deliver the service to the UE (116) within the energy profile identified by the AMF module (106). A step 220, SRC gNB sends a negative acknowledgement (NACK) message to the AMF module (106) when the SRC gNB is unable to deliver the service to the UE (116) within the energy profile identified by the AMF module (106). At step 222, on receiving the NACK message, the AMF module (106) may send an N1N2 message to the next optimal base station (e.g., target gNB). Target (TRG) gNB sends an ACK message to the AMF module (106) if it can deliver the service to the UE (116) within the energy profile identified by the AMF module (106). A handover request is sent from the AMF module (106) to the target gNB for a handover. This procedure may be referred as N2 HANDOVER procedure, which will be explained in detail with reference to FIG. 5.

FIG. 4 illustrates a sequence diagram of a method (400) for end-to-end network optimization, in accordance with an embodiment of the present disclosure.

Referring to FIG. 4, at step B1, ECF module (108) sends energy information of a base station, gNB, to AMF module (106). At step B2, the AMF module (106) estimates desired transmit power for UE (116) and gNB (112) based on the energy information. At step B3, the AMF module (106) sends a notification to the gNB (112), the notification including the gNB transmit power and UE transmit power.

At step B4, the gNB (112) adjusts its transmit power based on the received notification, and at step B5, gNB (112) transmits the UE transmit power to the UE (116). At step B6, the UE (116) adjusts its transmit power accordingly. At step B7, the UE (116) sends an acknowledge response to the gNB (112), and then at step B8, the gNB (112) sends the acknowledge response to the AMF module (106).

FIG. 5 illustrates a sequence diagram of a method (500) for N2 handover procedure, in accordance with an embodiment of the present disclosure.

Referring to FIG. 5, Namf_Communication_N1N2MessageTransfer is communicated to AMF module (106). At step C1, a source gNB (112-1) sends a measurement reports to the AMF module (106). At step C2, the AMF module (106) finds an optimal base station. At step C3, the AMF module (106) sends N2 PDU session request message to the source gNB (112-1). The source gNB (112-1) checks with its energy monitoring unit (e.g., 114-1) to determine whether it can provide the service to the UE (116) with the given energy constraints. If the source gNB (112-1) cannot provide the service, then at step C4, N2 message will be rejected.

At step C5, the AMF module (106) finds another optimal base station. At step C6, the AMF module (106) sends N2 message to a target gNB (112-2). The target gNB (112-2) checks with its energy monitoring unit (e.g., 114-2) to determine whether it can provide the service to the UE (116) with the given energy constraints or not. At step C7, the N2 message will be accepted, and at step C8, the target gNB (112-2) sends a N2 PDU session request ACK if it can provide the service. At step C9, the AMF module (106) sends a handover request to the target gNB (112-2). At step C10, the AMF module (106) builds a handover command message and sends it to the source gNB (112-1).

At step C11, a handover notify message is sent from the target gNB (112-2) to the AMF module (106). The UE (116) now completes the handover at the target gNB (112-2). The handover procedure ends. At step C12, the source gNB (112-1) receives a UE context (UE CTXT) release command from the AMF module (106). If there are PDU sessions that fail to setup at the target gNB (112-2), are released at SMF module (e.g., 102). A step C13, the source gNB (112-1) sends a UE context release command complete acknowledgement to the AMF module (106).

In some embodiments, if, at step C7, N2 message is rejected by the target gNB (112-2), then the AMF module (106) may identify another optimal base station and steps C6 from C13 may be repeated for the other optimal base station.

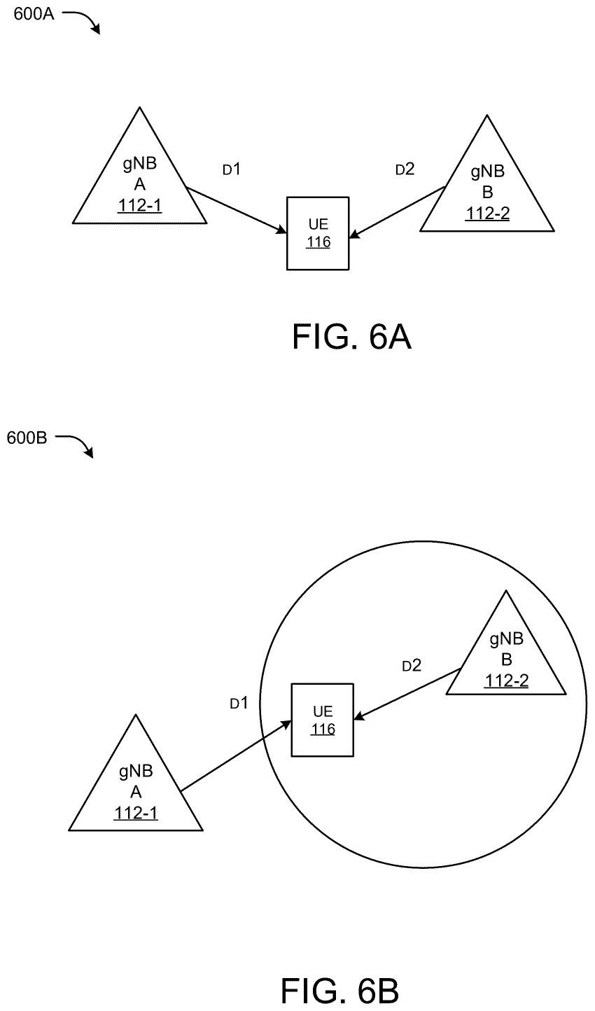

FIGS. 6A and 6B illustrate example representations (600A, 600B) for optimal base station selection, in accordance with embodiments of the present disclosure.

Referring to FIG. 6A, in an example embodiment, it may be assumed that AMF module (106) initiated handover of UE (116) from base station A (112-1) to base station B (112-2). Both base stations are local area base stations with d2>d1. In this example representation (600A), the transmit power of the UE (116) will increase as base station B (112-2) is far from UE (116) than base station A (112-1).

Referring to FIG. 6B, in an example embodiment, it may be assumed that AMF module (106) initiated handover of UE (116) from base station A (112-1) to base station B (112-2). Base station A (112-1) may be medium area base station and base station B (112-2) may be local area base station. UE transmission power may or may not be increased.

Therefore, the present disclosure identifies an optimal base station in this example representation (600B) such that the UE power may be similar or optimized further without impacting the service quality.

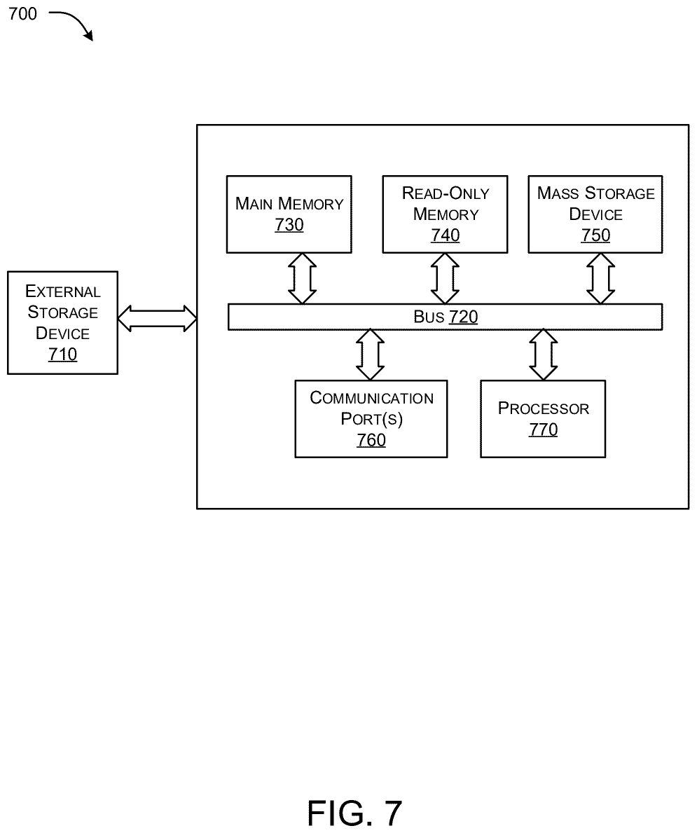

FIG. 7 illustrates an example computer system (700) in which or with which embodiments of the present disclosure may be implemented.

The blocks of the flow diagrams shown in FIGS. 2-5 have been arranged in a generally sequential manner for ease of explanation; however, it is to be understood that this arrangement is merely exemplary, and it should be recognized that the processing associated with methods (200, 300, 400, 500) may occur in a different order (for example, where at least some of the processing associated with the blocks is performed in parallel and/or in an event-driven manner). Further, it may be appreciated that the steps shown in FIGS. 2-5 are merely illustrative. Other suitable steps may be used for the same, if desired. Moreover, the steps of the method (200, 300, 400, 500) may be performed in any order and may include additional steps.

The methods and techniques described herein may be implemented in digital electronic circuitry, field programmable gate array (FPGA), or with a programmable processor (for example, a special-purpose processor or a general-purpose processor such as a computer) firmware, software, or in combinations of them. Apparatus embodying these techniques may include appropriate input and output devices, FPGA, a programmable processor, and a storage medium tangibly embodying program instructions for execution by the programmable processor. A process embodying these techniques may be performed by a programmable processor executing a program of instructions to perform desired functions by operating on input data and generating appropriate output. The techniques may advantageously be implemented in one or more programs that are executable on a programmable system, explained in detail with reference to FIG. 7, including at least one programmable processor coupled to receive data and instructions from, and to transmit data and instructions to, a data storage system, at least one input device, and at least one output device. Generally, a processor will receive instructions and data from a read-only memory and/or a random-access memory. Storage devices suitable for tangibly embodying computer program instructions and data include all forms of non-volatile memory, including by way of example semiconductor memory devices, such as erasable programmable read-only memory (EPROM), and flash memory devices; magnetic disks such as internal hard disks and removable disks; and magneto-optical disks. Any of the foregoing may be supplemented by, or incorporated in, specially designed application-specific integrated circuits (ASICs).

In particular, FIG. 7 illustrates an exemplary computer system (700) in which or with which embodiments of the present disclosure may be utilized. The computer system (700) may be implemented as or within the system (100) described in accordance with embodiments of the present disclosure.

As depicted in FIG. 7, the computer system (700) may include an external storage device (710), a bus (720), a main memory (730), a read-only memory (740), a mass storage device (750), communication port(s) (760), and a processor (770). A person skilled in the art will appreciate that the computer system (700) may include more than one processor (770) and communication ports (760). The processor (770) may include various modules associated with embodiments of the present disclosure. The communication port(s) (760) may be any of an RS-232 port for use with a modem-based dialup connection, a 10/100 Ethernet port, a Gigabit or 10 Gigabit port using copper or fiber, a serial port, a parallel port, or other existing or future ports. The communication port(s) (760) may be chosen depending on a network, such a Local Area Network (LAN), Wide Area Network (WAN), or any network to which the computer system (700) connects.

In an embodiment, the main memory (730) may be Random Access Memory (RAM), or any other dynamic storage device commonly known in the art. The read-only memory (740) may be any static storage device(s) e.g., but not limited to, a Programmable Read Only Memory (PROM) chips for storing static information e.g., start-up or basic input output system (BIOS) instructions for the processor (770). The mass storage device (750) may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces).

In an embodiment, the bus (720) communicatively couples the processor (770) with the other memory, storage, and communication blocks. The bus (720) may be, e.g., a Peripheral Component Interconnect (PCI)/PCI Extended (PCI-X) bus, Small Computer System Interface (SCSI), universal serial bus (USB), or the like, for connecting expansion cards, drives, and other subsystems as well as other buses, such a front side bus (FSB), which connects the processor (770) to the computer system (700).

In another embodiment, operator and administrative interfaces, e.g., a display, keyboard, and a cursor control device, may also be coupled to the bus (720) to support direct operator interaction with the computer system (700). Other operator and administrative interfaces may be provided through network connections connected through the communication port(s) (760). Components described above are meant only to exemplify various possibilities. In no way should the aforementioned exemplary computer system (700) limit the scope of the present disclosure.

Thus, it will be appreciated by those of ordinary skill in the art that the diagrams, schematics, illustrations, and the like represent conceptual views or processes illustrating systems and methods embodying this invention. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this invention. Those of ordinary skill in the art further understand that the exemplary hardware, software, processes, methods, and/or operating systems described herein are for illustrative purposes and, thus, are not intended to be limited to any particular named.

While the foregoing describes various embodiments of the invention, other and further embodiments of the invention may be devised without departing from the basic scope thereof. The scope of the invention is determined by the claims that follow. The invention is not limited to the described embodiments, versions or examples, which are included to enable a person having ordinary skill in the art to make and use the invention when combined with information and knowledge available to the person having ordinary skill in the art.

### ADVANTAGES OF THE PRESENT DISCLOSURE

The present disclosure provides a system and a method thereof for end-to-end network power optimization in a network.

The present disclosure facilitates to determine a policy for optimal base station selection both during initial cell selection by user equipment (UE) or cell reselection while the UE is in motion.

The present disclosure facilitates to determine the optimal base station based on UE characteristics, base station characteristics as well as the channel conditions.

The present disclosure facilitates to optimize the power by considering power profiles of UE, base station, traffic load, channel conditions such as path loss, receiver sensitivity, and the like.

We claim:

1. A method (200) for end-to-end network power optimization in an access network, comprising:
receiving (208), by a processor (870), a request message for session establishment from a primary base station (112-1) in the access network, wherein the primary base station (112-1) is attached to a user equipment (116) in the access network;
determining (210), by the processor (870), an energy profile corresponding to each of one or more secondary base stations (112-2) and the primary base station (112-1), the energy profile corresponding to a service associated with the user equipment (116);
determining (212), by the processor (870), an optimal base station, from among the primary base station (112-1) and the one or more secondary base stations (112-2), for enabling the service, based on a comparison of the energy profile of said each of the one or more secondary base stations (112-2) and the primary base station (112-1);
determining, by the processor (870), if the primary base station (112-1) and the optimal base station are same; and
in response to determining that the primary base station (112-1) and the optimal base station are same, transmitting, by the processor (870), a notification to the primary base station (112-1) and the user equipment (116); or
in response to determining that the primary base station (112-1) and the optimal base station are not same, initiating, by the processor (870), a handover of the user equipment (116) from the primary base station (112-1) to the determined optimal base station.

2. The method (200) as claimed in claim 1, wherein the energy profile comprises a set of network-monitored power parameters including at least one of: an identifier of a base station (112), an identifier of the service, a user subscription level, a power allocated for a resource element in the base station (112) for the service, a number of resource elements allocated for the service, a class of the base station (112), a rated carrier output power for the base station (112), a power amplifier efficiency in the base station (112), and a receiver sensitivity of the base station (112).

3. The method (200) as claimed in claim 1, wherein determining (212), by the processor (870), the optimal base station comprises:
receiving, by the processor (870), one or more power parameters from the primary base station (112-1) and the one or more secondary base stations (112-2);
estimating, by the processor (870), a path loss value of the user equipment (116) with respect to the one or more secondary base stations (112-2) based on the one or more power parameters; and
determining, by the processor (870), the optimal base station from among the primary base station (112-1) and the one or more secondary base stations (112-2) based at least on the path loss value.

4. The method (200) as claimed in claim 3, wherein the one or more power parameters comprise Synchronization Signal (SS) or Physical Broadcast Channel (PBCH) block power, and Reference Signal Received Power (RSRP) parameter in a measurement report from the user equipment (116).

5. The method (200) as claimed in claim 3, wherein if the user equipment (116) is switched on, determining, by the processor (870), the optimal base station comprises:
calculating, by the processor (870), a path loss offset value for the primary base station (112-1) and the one or more secondary base stations (112-2) based on receiver sensitivity values of the primary base station (112-1) and the one or more secondary base stations (112-2); and
calculating, by the processor (870), an effective path loss value corresponding to the primary base station (112-1) and the one or more secondary base stations (112-2) based on the path loss offset value and the path loss value; and
determining, by the processor (870), the optimal base station from among the primary base station (112-1) and the one or more secondary base stations (112-2) having the highest effective path loss value.

6. The method (200) as claimed in claim 3, wherein if the user equipment (116) is connected and moving, determining, by the processor (870), the optimal base station comprises:
estimating, by the processor (870), a downlink power required for the service corresponding to the primary base station (112-1) and the one or more secondary base stations (112-2);
estimating, by the processor (870), an uplink power required for the service corresponding to the user equipment (116);
determining, by the processor (870), a total power required for the service based at least on a first weighted value of the downlink power and a second weighted value of the uplink power; and
determining, by the processor (870), the optimal base station from among the primary base station (112-1) and the one or more secondary base stations (112-2) having the lowest total power.

7. The method (200) as claimed in claim 1, wherein the notification comprises a downlink power required for the service corresponding to the primary base station (112-1) and an uplink power required for the service corresponding to the user equipment (116).

8. The method (200) as claimed in claim 1, wherein in response to transmitting, by the processor (870), the notification to the primary base station (112-1), the method (200) comprises:
receiving, by the processor (870), an acknowledgement for accommodating the service according to the energy profile from the primary base station (112-1); or
receiving, by the processor (870), a negative acknowledgment from the primary base station (112-1).

9. The method (200) as claimed in claim 8, wherein in case of the negative acknowledgement, the method (200) comprises:
determining, by the processor (870), a target base station (112-2) as the optimal base station from among the one or more secondary base stations (112-2);
assigning, by the processor (870), the target base station (112-2) for accommodating the service; and
initiating, by the processor (870), the handover of the user equipment (116) from the primary base station (112-1) to the target base station (112-2).

10. The method (200) as claimed in claim 1, wherein initiating, by the processor (870), the handover of the user equipment (116) from the primary base station (112-1) to the optimal base station comprises:
transmitting, by the processor (870), the power profile corresponding to the service to the optimal base station; and
receiving, by the processor (870), an acknowledgement for accommodating the service according to the power profile from the optimal base station; or
receiving, by the processor (870), a negative acknowledgment from the optimal base station.

11. The method (200) as claimed in claim 6, wherein the first weighted value corresponds to a first power optimization parameter, wherein the second weighted value corresponds to a second power optimization parameter, and wherein the method (200) comprises:
adaptively determining, by the processor (870), the first power optimization parameter and the second power optimization parameter based on a user subscription level corresponding to the user equipment (116).

12. A system (100) for end-to-end network power optimization in an access network, comprising:
a processor (870); and
a memory (840) operatively coupled with the processor (870), wherein the memory (840) comprises processor-executable instructions which, when executed by the processor (870), cause the processor (870) to:
receive a request message for session establishment from a primary base station (112-1) in the access network, wherein the primary base station (112-1) is attached to a user equipment (116) in the access network;
determine an energy profile corresponding to each of one or more secondary base stations (112-2) and the primary base station (112-1), the energy profile corresponding to a service associated with the user equipment (116);
determine an optimal base station, from among the primary base station (112-1) and the one or more secondary base stations (112-2), for enabling the service, based on a comparison of the energy profile of said each of the one or more secondary base stations (112-2) and the primary base station (112-1);
determine if the primary base station (112-1) and the optimal base station are same; and
in response to determining that the primary base station (112-1) and the optimal base station are same, transmit a notification to the primary base station (112-1) and the user equipment (116); or
in response to determining that the primary base station (112-1) and the optimal base station are not same, initiate a handover of the user equipment (116) from the primary base station (112-1) to the determined optimal base station.

13. A user equipment (116), comprising:
a processor (870); and
a memory (840) operatively coupled with the processor (870), wherein the memory (840) comprises processor-executable instructions which, when executed by the processor (870), cause the processor (870) to:
receive a Synchronization Signal Block (SSB) signal from each of one or more base stations (112) in an access network;
determine Reference Signal Received Power (RSRP) parameter for each of the one or more base stations (112) based on the SSB signal;
initiate a connection with a primary base station (112-1) of the one or more base stations (112) based on the RSRP parameter; and
receive a notification from a network entity in a core network (124) based on a power profile of the one or more base stations (112), the notification indicating one of:
adjust an uplink power to accommodate the service; or
initiate a handover from the primary base station (112-1) to a secondary base station (112-2) of the one or more base stations (112).
